(19) United States
(12) Patent Application Publication
(10) Pub. No.: US 2019/0297220 A1
(43) Pub. Date: Sep. 26, 2019

(54) Image Processing Apparatus

(71) Applicant: Kyocera Document Solutions Inc., Osaka (JP)

(72) Inventor: Tetsuya Nishino, Osaka (JP)

(21) Appl. No.: 16/361,218

(22) Filed: Mar. 22, 2019

(30) Foreign Application Priority Data
Mar. 23, 2018 (JP) 2018-057067

(51) Int. Cl. H04N 1/32; G06T 3/40

(52) U.S. Cl. CPC H04N 1/32267; H04N 1/32037; G06T 3/4038

(57) ABSTRACT

An image processing apparatus includes a raw image obtaining unit, a combined image generating unit, and a stamp image composing unit. The raw image obtaining unit obtains N raw images for generating an N-up image. The combined image generating unit generates the combined image from the obtained raw images. The stamp image composing unit selects a stamp image adapted for a combined image generating condition from a plurality of stamp images having mutually different layouts of stamps to compose the selected stamp image on the combined image.

### INCORPORATION BY REFERENCE

This application is based upon, and claims the benefit of priority from, corresponding Japanese Patent Application No. 2018-057067 filed in the Japan Patent Office on Mar. 23, 2018, the entire contents of which are incorporated herein by reference.

### BACKGROUND

Unless otherwise indicated herein, the description in this section is not prior art to the claims in this application and is not admitted to be prior art by inclusion in this section.

A certain image processing apparatus divides a stamp into a plurality of divided parts before combining a plurality of raw images, and composes the plurality of divided parts of the stamp on the respective plurality of raw images in an N-up print. This ensures the composed stamp over the plurality of raw images in a page image after combining (hereinafter, referred to as combined image).

### SUMMARY

An image processing apparatus according to one aspect of the disclosure includes a raw image obtaining unit, a combined image generating unit, and a stamp image composing unit. The raw image obtaining unit obtains N raw images for generating an N-up image. The combined image generating unit generates the combined image from the obtained raw images. The stamp image composing unit selects a stamp image adapted for a combined image generating condition from a plurality of stamp images having mutually different layouts of stamps to compose the selected stamp image on the combined image.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a block diagram illustrating a configuration of an image processing apparatus according to Embodiment 1 of the disclosure;

FIG. 2 illustrates a behavior of the image processing apparatus according to Embodiment 1 when a copy job is executed;

FIG. 3 illustrates one example of a stamp image and a composite image of a combined image and the stamp image when the number of combinations N is two, a document size is A4, and an orientation of the combined image is a landscape;

FIG. 4 illustrates one example of a stamp image and a composite image of a combined image and the stamp image when the number of combinations N is four, the document size is A4, and the orientation of the combined image is the landscape;

FIG. 5 illustrates one example of a stamp image and a composite image of a combined image and the stamp image when the number of combinations N is two, the document size is A4, and the orientation of the combined image is a portrait;

FIG. 6 illustrates one example of a stamp image and a composite image of a combined image and the stamp image when the number of combinations N is four, the document size is A4, and the orientation of the combined image is the portrait; and

FIG. 7 illustrates a behavior of the image processing apparatus according to Embodiment 1 when a print job is executed.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes embodiments of the disclosure based on the drawings.

### Embodiment 1

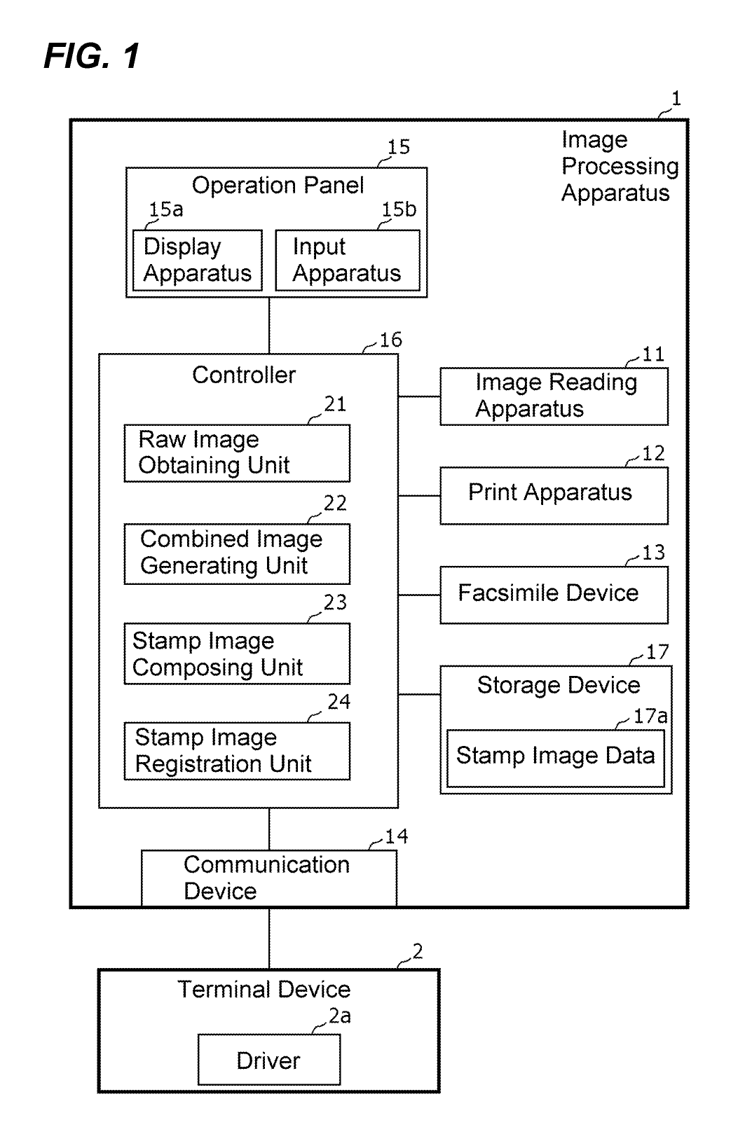

FIG. 1 illustrates a configuration of an image processing apparatus according to Embodiment 1 of the disclosure. An image processing apparatus 1 illustrated in FIG. 1 is an image forming apparatus, such as a multi-functional peripheral. The image processing apparatus 1 illustrated in FIG. 1 includes, for example, an image reading apparatus 11, a print apparatus 12, a facsimile device 13, a communication device 14, an operation panel 15, a controller 16, and a storage device 17.

The image reading apparatus 11 is an internal unit that optically reads a document image from a document placed on a platen glass and a document fed by an automatic document feeder with a specified resolution to generate image data of the document image.

The print apparatus 12 is an internal unit that prints, for example, the document image and a combined image.

The facsimile device 13 is an internal unit that transmits the image data obtained by a scan as a facsimile signal, and receives a facsimile signal to generate the image data. The communication device 14 is, for example, a network interface and a short-range communication interface, and is an internal unit that performs a data communication with a terminal device and a server, which are not illustrated.

The operation panel 15 is an internal unit that is arranged on a housing top surface side of this image reading apparatus, and includes a display apparatus 15a that displays an operation screen for a user and an input apparatus 15b that accepts user's operations. The display apparatus 15a is, for example, a liquid crystal display. The input apparatus 15b is, for example, a hardware key and a touch panel that achieves a software key together with the display apparatus 15a.

The controller 16 includes, for example, a computer including, for example, a Central Processing Unit (CPU), a Read Only Memory (ROM), and a Random Access Memory (RAM), and an Application Specific Integrated Circuit (ASIC). The controller 16 behaves as various kinds of processing units. That is, the controller 16 loads a program stored in the ROM and the storage device 17 into the RAM, and executes the program in the CPU to behave as the various kinds of processing units by software, or use, for example, the ASIC to behave as the various kinds of processing units by hardware. The controller 16 controls the internal units to execute various kinds of process.

The storage device 17 is a non-volatile storage device, such as a flash memory, and stores data and programs. The storage device 17 stores, for example, stamp image data 17a.

The controller 16 behaves as a raw image obtaining unit 21, a combined image generating unit 22, a stamp image composing unit 23, and a stamp image registration unit 24.

The raw image obtaining unit 21 obtains N raw images (a plurality of document page images) for generating an N-up image. When a copy job is executed, the image reading apparatus 11 reads the raw images from the documents, and the raw image obtaining unit 21 obtains the raw images from the image reading apparatus 11. When a print job is executed, the communication device 14 communicates with a driver 2a in an external terminal device 2, and the raw image obtaining unit 21 obtains the raw images from the driver 2a by using the communication device 14.

The combined image generating unit 22 generates a combined image from the obtained raw images.

The stamp image composing unit 23 selects a stamp image adapted for a combined image generating condition (such as number of combinations N and document size) from a plurality of stamp images having mutually different layouts of stamps to compose the selected stamp image on the combined image. This plurality of stamp images are stored in the storage device 17 as the stamp image data 17a.

For example, the stamp image composing unit 23 refers to a table indicating correspondence relationships between a plurality of the combined image generating conditions and the plurality of stamp images to select the stamp image adapted for the combined image generating condition.

When the copy job is executed, the stamp image composing unit 23 identifies an orientation of the document set on the image reading apparatus 11 as the combined image generating condition, and identifies an orientation (portrait or landscape) of the above-described combined image based on the identified document orientation to select a stamp image adapted for the identified combined image orientation.

When the print job is executed, the stamp image composing unit 23 identifies a printing orientation specified by the driver 2a as the combined image generating condition, and based on the identified printing orientation, an orientation of the above-described combined image is identified to select a stamp image adapted for the identified combined image orientation.

In this embodiment, the above-described plurality of stamp images are stored in a respective plurality of document boxes. The stamp image composing unit 23: (a) selects a document box adapted for the combined image generating condition from the above-described plurality of document boxes; and (b) selects a stamp image stored in the selected document box.

The stamp image registration unit 24 stores an image specified by a user in the above-described document box as a stamp image. For example, the image reading apparatus 11 reads a stamp image from a document on which the stamp image is printed, and the stamp image is stored as image data in a document box that corresponds to a combination of, for example, a raw image size, a raw image orientation, and the number of combinations N of a combined image that are specified by the user. Thus, a stamp can be composed to a user's desired position in the combined image. The stamp image is an image having a size identical to that of the combined image.

Next, a description will be given of a behavior of the above-described image processing apparatus.

(a) When a copy job is executed.

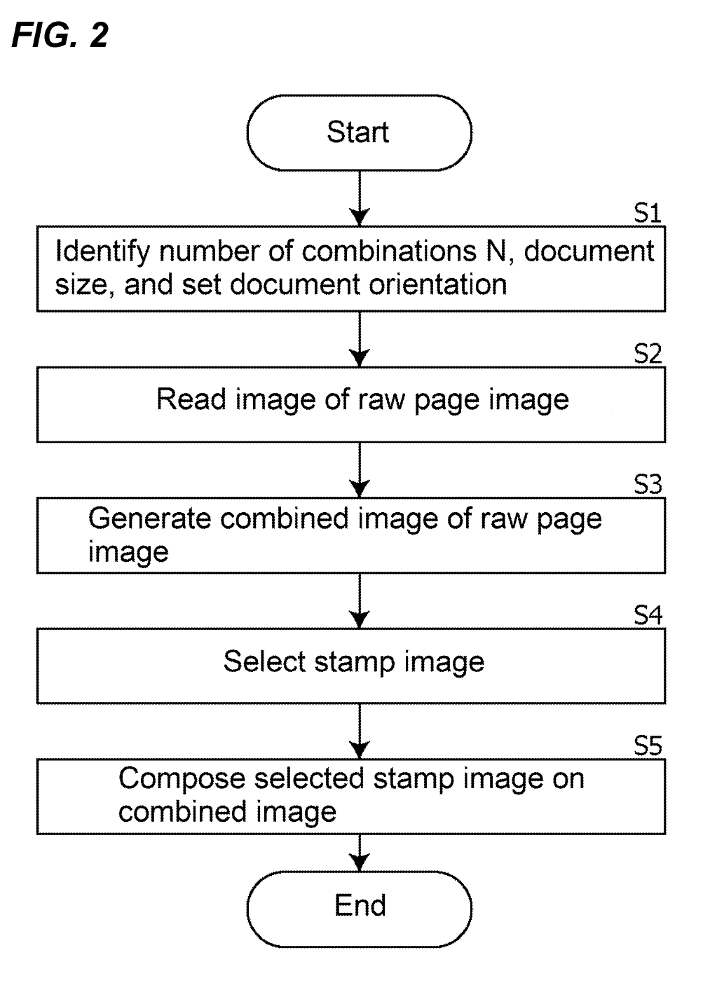

FIG. 2 illustrates a behavior of the image processing apparatus illustrated in FIG. 1 when the copy job is executed.

When the controller 16 accepts a request of a copy job associated with an N-up print, the raw image obtaining unit 21 identifies job settings, such as a document size and the number of combinations N, (that is, combined image generating condition) specified by user's operations, and furthermore, identifies a set document orientation (that is, combined image generating condition) of documents set on the platen glass or the automatic document feeder (Step 51).

Next, the raw image obtaining unit 21 controls the image reading apparatus 11 to cause the image reading apparatus 11 to execute a reading of raw images for a combined image from the documents, and obtains the raw image from the image reading apparatus 11 (Step S2).

The combined image generating unit 22 generates the combined image of the specified number of combinations N from the obtained raw images (Step S3).

Then, the stamp image composing unit 23 selects a stamp image adapted for a combination (that is, combined image generating condition) of, for example, the above-described document size, number of combinations N, and set document orientation (Step S4).

At this time, when the document size is A4, a page orientation setting of the image reading apparatus 11 is top edge on top, and an actually set document orientation (that is, orientation of document sheet) is A4R (that is, vertical direction in which long side is parallel to main-scanning orientation), the orientation of the combined image is determined to be the landscape. In this case, a stamp image stored in a document box #1 is selected.

When the document size is A4, the page orientation setting of the image reading apparatus 11 is top edge on top, and the actually set document orientation is A4E (that is, horizontal direction in which long side is parallel to sub-scanning orientation), the orientation of the combined image is determined to be the portrait. In this case, a stamp image stored in a document box #2 is selected.

When the document size is A4, the page orientation setting of the image reading apparatus 11 is top edge on left, and the actually set document orientation is A4R, the orientation of the combined image is determined to be the portrait. In this case, the stamp image stored in the document box #2 is selected.

When the document size is A4, the page orientation setting of the image reading apparatus 11 is top edge on left, and the actually set document orientation is A4E, the orientation of the combined image is determined to be the landscape. In this case, the stamp image stored in the document box #1 is selected.

When the document size is A3, the page orientation setting of the image reading apparatus 11 is top edge on top, and the actually set document orientation is A3E, the orientation of the combined image is determined to be the landscape. In this case, the stamp image stored in a document box #3 is selected.

When the document size is A3, the page orientation setting of the image reading apparatus 11 is top edge on left, and the actually set document orientation is A3E, the orientation of the combined image is determined to be the portrait. In this case, a stamp image stored in a document box #4 is selected.

Here, while the stamp image is selected regardless of the number of combinations N, a different stamp image may be selected corresponding to the number of combinations N.

After selecting the stamp image, the stamp image composing unit 23 reads the selected stamp image from the storage device 17 to compose the selected stamp image on the combined image (Step S5).

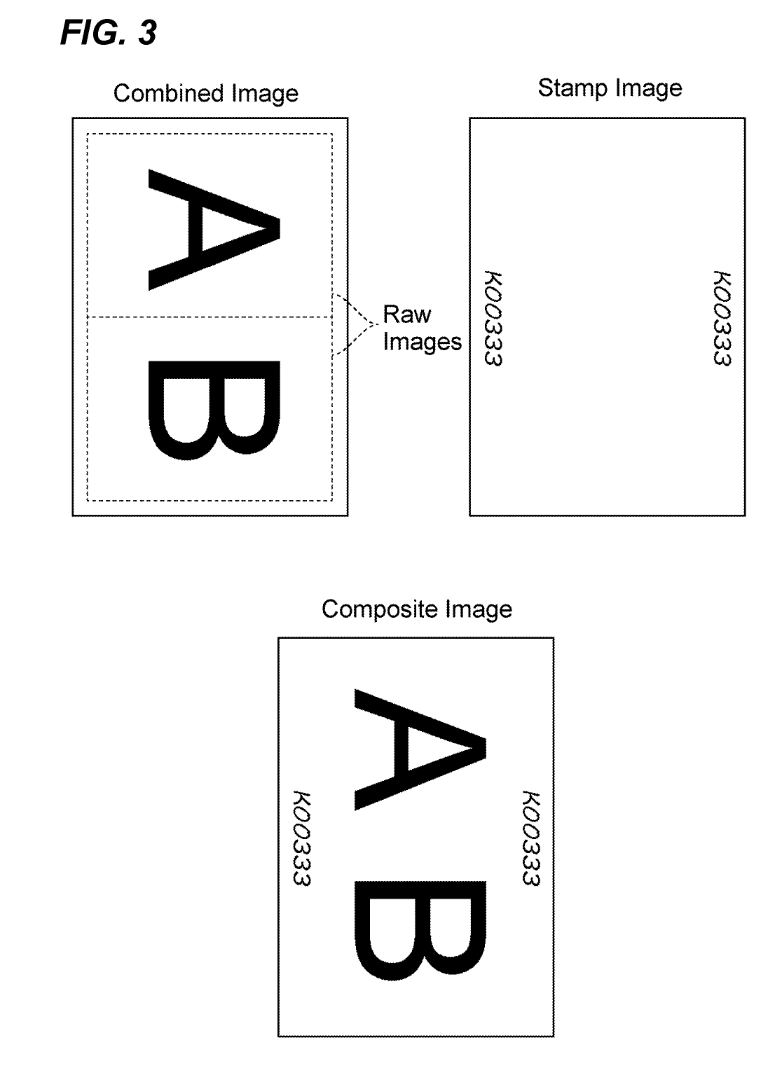

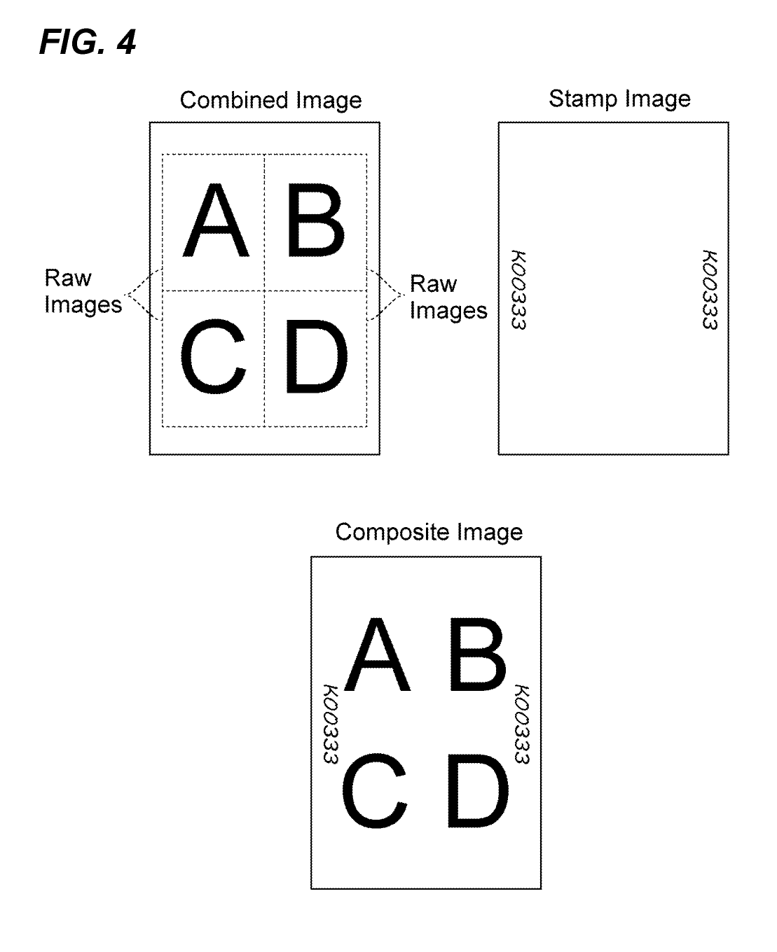

FIG. 3 illustrates one example of a stamp image and a composite image of a combined image and the stamp image when the number of combinations N is two, the document size is A4,and the orientation of the combined image is the landscape. FIG. 4 illustrates one example of a stamp image and a composite image of a combined image and the stamp image when the number of combinations N is four, the document size is A4, and the orientation of the combined image is the landscape.

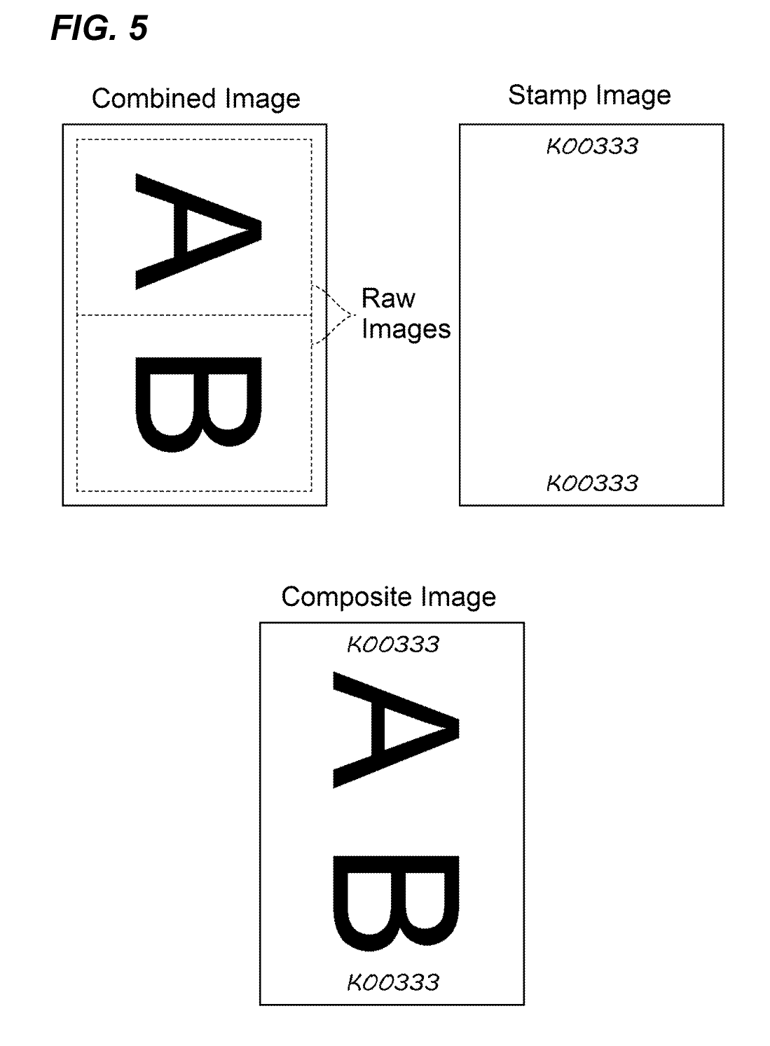

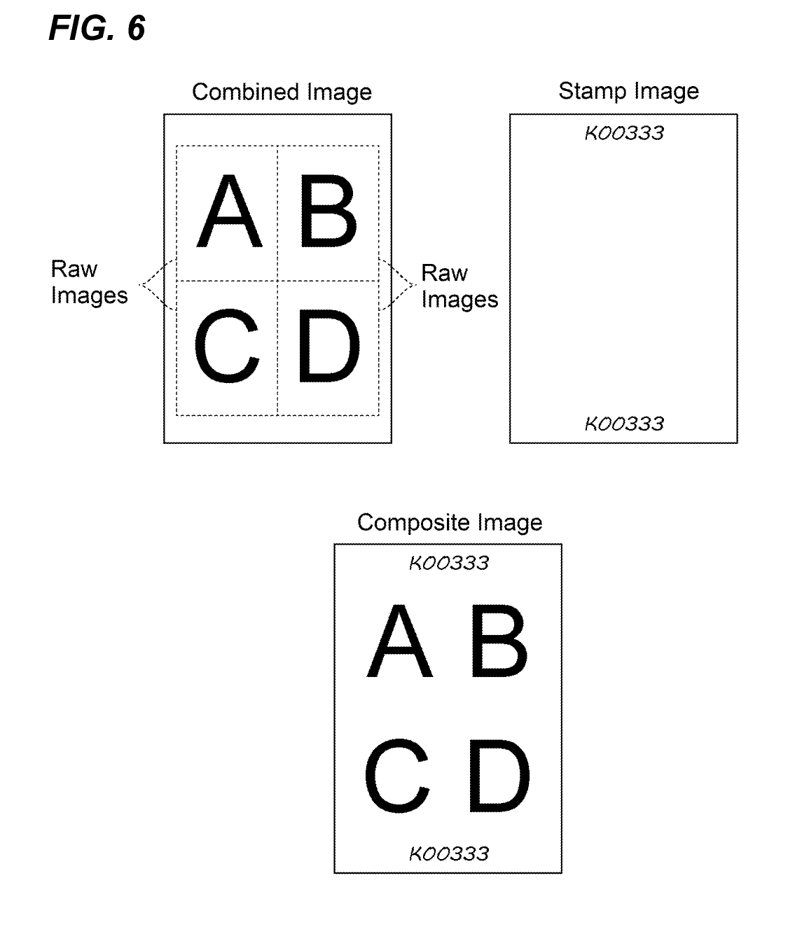

FIG. 5 illustrates one example of a stamp image and a composite image of a combined image and the stamp image when the number of combinations N is two, the document size is A4, and the orientation of the combined image is the portrait. FIG. 6 illustrates one example of a stamp image and a composite image of a combined image and the stamp image when the number of combinations N is four, the document size is A4, and the orientation of the combined image is the portrait.

For example, when: a stamp image like ones illustrated in FIGS. 3 and 4 (stamp image that locates stamps (character string and figure) in margin portions in top side center and lower side center with respect to combined image in landscape orientation) is stored in the document box #1; and a stamp image like ones illustrated in FIGS. 5 and 6 (stamp image that locates stamps (character string and figure) in margin portions in top side center and lower side center with respect to combined image in portrait orientation) is stored in the document box #2, once the orientation of the combined document is determined to be the landscape, the stamp image is composed as illustrated in FIGS. 3 and 4, and once the orientation of the combined document is determined to be the portrait, the stamp image is composed as illustrated in FIGS. 5 and 6.

When the number of combinations is four, the document size is A3, and the orientation of the combined document is the landscape, for example, a stamp image in which four stamps are arranged to correspond to respective centers of the long sides on outer sides of four raw images in the combined image is stored in the document box #3 and used.

The composite image thus generated (that is, combined image on which stamp image is composed) is printed by the print apparatus 12 in the copy job. When a transmitting job is executed, image data of the composite image generated as described above may be transmitted with, for example, the facsimile device 13 (when facsimile transmitting job is executed) or the communication device 14 to an external device (such as the terminal device 2) (when sending job is executed).

(b) When a print job is executed.

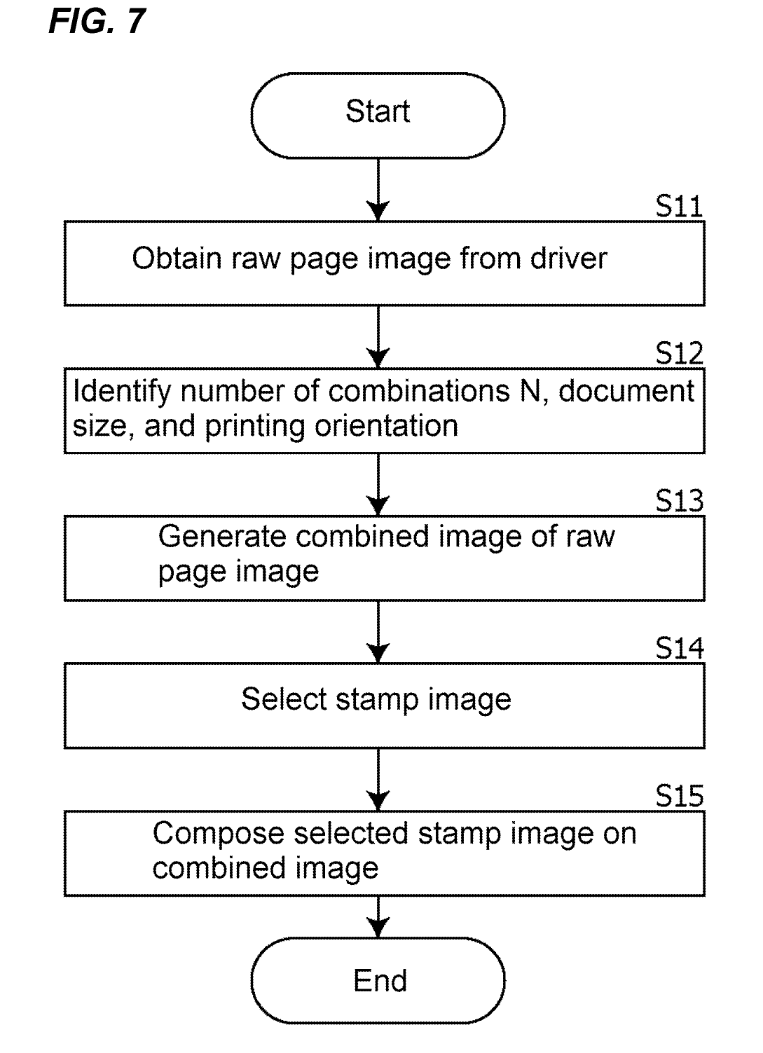

FIG. 7 illustrates a behavior of the image processing apparatus illustrated in FIG. 1 when the print job is executed.

When the controller 16 accepts a request of a print job associated with an N-up print from the driver 2a, the raw image obtaining unit 21 uses the communication device 14 to receive print data transmitted from the driver 2a, and extracts a raw image from the print data or converts the print data into a raw image (Step S11). The raw image obtaining unit 21 identifies, for example, the number of combinations N, the document size, and the printing orientation as a printing condition setting (that is, combined image generating condition) based on the print data (Step S12).

Next, the combined image generating unit 22 generates a combined image of the specified number of combinations N from the obtained raw images (Step S13).

Then, the stamp image composing unit 23 selects a stamp image adapted for a combination (that is, combined image generating condition) of, for example, the above-described document size, number of combinations N, and printing orientation (Step S14).

At this time, when the document size is A4 and the printing orientation is vertical, it is determined that the orientation of the combined image is the portrait. In this case, the stamp image stored in the document box #2 is selected.

When the document size is A4 and the printing orientation is horizontal, it is determined that the orientation of the combined image is the landscape. In this case, the stamp image stored in the document box #1 is selected.

At this time, when the document size is A3 and the printing orientation is vertical, it is determined that the orientation of the combined image is the portrait. In this case, the stamp image stored in the document box #4 is selected.

When the document size is A3 and the printing orientation is horizontal, it is determined that the orientation of the combined image is the landscape. In this case, the stamp image stored in the document box #3 is selected.

Here, while the stamp image of the print job and the stamp image of the copy job are shared and used, a stamp image different from the stamp image of the copy job may be used as the stamp image of the print job.

After selecting a stamp image, the stamp image composing unit 23 reads the selected stamp image from the storage device 17 to compose the selected stamp image on the combined image (Step S15).

The composite image thus generated (that is, combined image on which stamp image is composed) is printed by the print apparatus 12 in the print job. Image data of the composite image generated as described above may be transmitted to the external device (such as the terminal device 2) with, for example, the facsimile device 13 and the communication device 14.

As described above, according to the above-described embodiment, the raw image obtaining unit 21 obtains N raw images for generating the N-up image. The combined image generating unit 22 generates the combined image from the obtained raw images. The stamp image composing unit 23 selects the stamp image adapted for the combined image generating condition from the plurality of stamp images having the mutually different layouts of stamps to compose the selected stamp image on the combined image.

This locates the stamp at a position corresponding to a generating condition of the N-up image, and thus, the stamp is composed at the appropriate position within the combined image in generating the N-up image.

### Embodiment 2

In an image processing apparatus according to Embodiment 2, the above-described table that indicates the correspondence relationships between the plurality of combined image generating conditions and the plurality of stamp images can be edited or generated by the user.

In Embodiment 2, when the input apparatus 15b detects a predetermined user's operation, the stamp image registration unit 24: (a) displays options per item of the combined image generating condition on the display apparatus 15a; (b) detects the user's operation that selects one of the options of the item as a set value of the item with the input apparatus 15b; (c) after set values for all the items of the combined image generating condition are selected, identifies this combined image generating condition as the combination of the set values of these items; (d) detects the user's operation that selects a stamp image (specifically, a document box that stores the stamp image) adapted for the combined image generating condition with the input apparatus 15b; and (e) after the stamp image is selected, registers a correspondence relationship between the combined image generating condition and the stamp image in the above-described table.

The above-described table: (a) may be a shared table for, for example, a copy job, a transmitting job (a sending job or a facsimile transmitting job), and a print job; or (b) may be a plurality of different tables for the copy job and the transmitting job, and the print job to be used by selecting the table corresponding to the job type.

For example, when a table is for the copy job and transmitting job, the items include, for example, the document size, the page orientation, the number of combinations, the user (such as user name and user ID) (when user authentication is on), and a department (such as department name and department ID) (when department management is on). Then, the options of the item “document size” include, for example, Ledger, LetterR, Letter, Legal, StatementR, Statement, 11×15, Oficio2, 8K, 16KR, 16K, A3R, A4R, A4, A5R, A5, A6, B4R, B4, B5R, B5, B6R, B6, and Folio. The options of the item “page orientation” include, for example, setting a document upper edge to the back and setting the document upper edge to the left. The options of the item “number of combinations” include, for example, one (that is, no combination), two (that is, 2 in 1), and four (that is, 4 in 1). The options of the item “user” or the item “department” include, for example, a user or a user name of department, and a user ID, or a department name and a department ID registered in advance.

For example, when a table is for the print job, the items include, for example, the document size, the printing orientation, the number of combinations, the user (such as user name and user ID) (when user authentication is on), and the department (such as department name and department ID) (when department management is on). Then, the options of the item “document size” include, for example, Ledger, LetterR, Letter, Legal, StatementR, Statement, 11×15, Oficio2, 8K, 16KR, 16K, A3R, A4R, A4, A5R, A5, A6, B4R, B4, B5R, B5, B6R, B6, and Folio. The options of the item “printing orientation” include, for example, vertical, horizontal, vertical 180 degree rotation, and horizontal 180 degree rotation. The options of the item “number of combinations” include, for example, one (that is, no combination), two (that is, 2 in 1), and four (that is, 4 in 1). The options of the item “user” or the item “department” include, for example, the user or the user name of the department, and the user ID, or the department name and the department ID registered in advance.

Then, when a job is executed, the stamp image composing unit 23 refers to the table to select the stamp image adapted for the combined image generating condition. At this time, when the copy job and the transmitting job have the table different from that of the print job, the stamp image composing unit 23 selects the table corresponding to the job type of the job, and refers to the selected table to select the stamp image adapted for the combined image generating condition.

Other configurations and behaviors of the image processing apparatus according to Embodiment 2 are similar to those of Embodiment 1, and thus, the description is omitted.

As described above, with above-described Embodiment 2, the above-described table (that is, correspondence relationships between combined image generating conditions and stamps image) can be customized by the user.

Various changes and corrections to the above-described embodiments are apparent for those skilled in the art. Such changes and corrections may be made without departing from the gist and scope of the subject, and without weakening the intended advantages. That is, it is intended that such changes and corrections are included in the claims.

For example, in above-described Embodiments 1 and 2, the stamp image composing unit 23 may switch the plurality of stamp images corresponding to any one of the user, the user's department, and a time attribute of a day on which the combined image is generated (such as day of week, week, month, and year).

In above-described Embodiments 1 and 2, instead of associating the document box with the combined image generating condition, the stamp image composing unit 23 may directly identify and select the stamp image adapted for the combined image generating condition regarding the combined image on which the stamp image should be composed by associating each of a name and a file path of the stamp image with the combined image generating condition.

The disclosure is applicable to an image forming apparatus, such as a multi-functional peripheral.

### Exemplary Embodiment of the Disclosure

An image processing apparatus according to the disclosure includes a raw image obtaining unit, a combined image generating unit, and a stamp image composing unit. The raw image obtaining unit obtains N raw images for generating an N-up image. The combined image generating unit generates the combined image from the obtained raw images. The stamp image composing unit selects a stamp image adapted for a combined image generating condition from a plurality of stamp images having mutually different layouts of stamps to compose the selected stamp image on the combined image.

### Effects of the Disclosure

The disclosure provides an image processing apparatus that composes a stamp at an appropriate position within a combined image in generating an N-up image.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An image processing apparatus comprising:
a raw image obtaining unit that obtains N raw images for generating an N-up image;
a combined image generating unit that generates the combined image from the obtained raw images; and
a stamp image composing unit that selects a stamp image adapted for a combined image generating condition from a plurality of stamp images having mutually different layouts of stamps to compose the selected stamp image on the combined image.

2. The image processing apparatus according to claim 1, further comprising
an image reading apparatus that reads the raw image from a document,
wherein the raw image obtaining unit obtains the raw image from the image reading apparatus, and
the stamp image composing unit: (a) identifies an orientation of the document set on the image reading apparatus as the combined image generating condition; (b) identifies an orientation of the combined image based on the identified orientation of the document; and (c) selects a stamp image adapted for the orientation of the combined image.

3. The image processing apparatus according to claim 1, further comprising
a communication device that communicates with a driver in an external terminal device,
wherein the raw image obtaining unit obtains the raw image from the driver by using the communication device, and
the stamp image composing unit: (a) identifies a printing orientation specified by the driver as the combined image generating condition; (b) identifies an orientation of the combined image based on the identified printing orientation; and (c) selects a stamp image adapted for the orientation of the combined image.

4. The image processing apparatus according to claim 1,
wherein the plurality of stamp images are stored in a respective plurality of document boxes, and
the stamp image composing unit: (a) selects a document box adapted for the combined image generating condition from the plurality of document boxes; and (b) selects a stamp image stored in the selected document boxes.

5. The image processing apparatus according to claim 4, further comprising
a stamp image registration unit that stores an image specified by a user in the document box as the stamp image.

6. The image processing apparatus according to claim 1,
wherein the stamp image composing unit switches the plurality of stamp images corresponding to any one of user, user's department, and time attribute of a day on which the combined image is generated.

7. The image processing apparatus according to claim 5,
wherein the stamp image registration unit: (a) displays options per item of the combined image generating condition on a display apparatus; (b) detects a user's operation that selects one of the options of the item as a set value of the item with an input apparatus; (c) after set values for all the items of the combined image generating condition are selected, identifies the combined image generating condition as a combination of the set values of the items; (d) detects a user's operation that selects a stamp image adapted for the combined image generating condition with the input apparatus; and (e) after the stamp image is selected, registers a correspondence relationship between the combined image generating condition and the stamp image in a table, and
the stamp image composing unit refers to the table to select the stamp image adapted for the combined image generating condition.

8. The image processing apparatus according to claim 7,
wherein the stamp image registration unit registers correspondence relationships between the combined image generating conditions and the stamps image in the table corresponding to a respective plurality of job types, and
the stamp image composing unit refers to the table selected corresponding to a job type of a job to be executed to select the stamp image adapted for the combined image generating condition.
